(19) United States
(12) Patent Application Publication
(10) Pub. No.: US 2016/0255809 A1
(43) Pub. Date: Sep. 8, 2016

(54) Washing Device

(71) Applicant: Telebrands Corp., Fairfield, NJ (US)

(72) Inventors: Paul DOWD, Scarsdale, NY (US); Ryan Andrew DIEZ, Valencia, CA (US); Erol SEARFOSS, Brooklyn, NY (US)

(21) Appl. No.: 15/153,120

(22) Filed: May 12, 2016

Related U.S. Application Data
(63) Continuation-in-part of application No. 14/805,464, filed on Jul. 21, 2015.
(60) Provisional application No. 62/026,798, filed on Jul. 21, 2014.

(51) Int. Cl. A01K 13/00; B05B 7/04; B05B 1/20

(52) U.S. Cl. CPC A01K 13/001; B05B 1/207; B05B 7/0408

(57) ABSTRACT

A washing device including a connector configured to removably couple the washing device to a fluid source, an encapsulating element including a first segment and a second segment, the encapsulating element including a plurality of openings, a pivoting mechanism coupling the first and second segments, the pivoting mechanism providing relative adjustment between the first and second segments, and a flow path providing fluid communication from the fluid source to the plurality of openings when the washing device is coupled to the fluid source via the connector.

### CROSS REFERENCE TO PRIOR APPLICATIONS

This application is a continuation-in-part of U.S. non-provisional application Ser. No. 14/805,464 filed Jul. 21, 2015, which claims benefit to U.S. provisional application Ser. No. 62/026,798 filed Jul. 21, 2014, the disclosure of both applications are incorporated herein by reference in their entireties.

### FIELD

Embodiments of the present invention are generally directed to a handheld device for wetting, washing and/or rinsing animals, objects or people.

### BACKGROUND

Exemplary embodiments of the present invention generally relate to handheld devices that wash animals, objects or humans, and more specifically canines, referred to herein as “dogs”.

Other devices known in the art simply spray water and/or dispense soap from a single point. With the known technology, soap and water can only be dispensed where the spray is aimed. The current known devices do not distribute soapy water or rinse the dog from all sides, unless the user changes the direction of the spray. Using known devices is time consuming because it does not distribute the water and/or soap over the entire dog. Ultimately, currently known devices generally do not provide full coverage of soap and an entire rinse.

Embodiments of the present invention are generally directed to a handheld washing device, which encapsulates an animal in streams of soap and/or water, leaving no area of an animal's body dry or un-bathed. The devices described herein spray water from all sides simultaneously, which shortens the time it takes to wash any animal, more specifically dogs. It also effectively cleans an animal's coat while washing the entirety of its body.

### SUMMARY

Embodiments of the present invention can provide a washing device. The washing device can include a connector configured to removably couple the washing device to a fluid source, an encapsulating element including a first segment and a second segment, the encapsulating element including a plurality of openings, a pivoting mechanism coupling the first and second segments, the pivoting mechanism providing relative adjustment between the first and second segments, and a flow path providing fluid communication from the fluid source to the plurality of openings when the washing device is coupled to the fluid source via the connector.

The encapsulating element can also include a third segment and a fourth segment, and a second pivoting mechanism connecting the third segment to the fourth segments. The second pivoting mechanism can provide relative adjustment between the third and fourth segments. Further, encapsulating element can be comprised of a flexible flaccid material, which expands when fluid pressure is applied, and returns to its original flaccid form when fluid pressure is removed. The washing can also include a soap dispensing mechanism configured to provide a soap to the flow path, a water pressure modulator, and/or a handle rotatably coupled to the encapsulating element. The washing device can also include a third pivoting mechanism coupling the first segment to the handle and a fourth pivoting mechanism coupling the third segment to the handle. The third pivoting mechanism can provide relative adjustment between the first segment and the handle and the fourth pivoting mechanism can provide relative adjustment between the third segment and the handle.

Another embodiment of the present invention can provide a washing device including a connector configured to removably couple the washing device to a fluid source, an encapsulating element including a plurality of openings, a handle, a pivoting mechanism coupling the encapsulating element to the handle, the pivoting mechanism providing relative adjustment between the encapsulating element and the handle; and a flow path providing fluid communication from the fluid source to the plurality of openings when the washing device is coupled to the fluid source via the connector.

The encapsulating element can also include first segment coupled to a second segment via a second pivoting mechanism. The second pivoting mechanism can provide relative adjustment between the first and second segments. The encapsulating element can also include a third segment coupled to the handle via a third pivoting mechanism. The third pivoting mechanism can provide relative adjustment between the third segment and handle. The encapsulating element can further include a fourth segment coupled to the third segment via a fourth pivoting mechanism. Further, encapsulating element can be comprised of a flexible flaccid material, which expands when fluid pressure is applied, and returns to its original flaccid form when fluid pressure is removed. The washing can also include a soap dispensing mechanism configured to provide a soap to the flow path and/or a water pressure modulator.

Yet another embodiment of the present invention can provide a washing device including a connector configured to removably couple the washing device to a fluid source, an encapsulating element having a plurality of openings coupled to the connector, and a flow path providing fluid communication from the fluid source to the plurality of openings when the washing device is coupled to the fluid source via the connector.

The washing device can further include a handle rotatably coupled to the encapsulating element, a soap dispensing mechanism configured to provide a soap to the flow path, and/or a water pressure modulator. Further, the encapsulating element can be comprised of a flexible flaccid material, which expands when fluid pressure is applied, and returns to its original flaccid form when fluid pressure is removed.

Embodiments of present invention can provide a washing device, including a soap dispenser and an encapsulating element. The soap dispenser has a first end and a second end. The first end couples to a water source. The second end can be coupled to the encapsulating element. The encapsulating element can include a series of openings. When water pressure is increased from the water source, water flows freely from the water source through the first end of the soap dispenser, and is released through the second end of the soap dispenser into the encapsulating element, and is ultimately released through the openings of the encapsulating element.

In another embodiment, the embodiments of present invention can provide a wetting or rinsing device, including a water dispenser and an encapsulating element. The waster dispenser has a first end and a second end. The first end couples to a water source. The second end can be coupled to the encapsulating element. The encapsulating element has a series of openings. When water pressure is increased from the water source, water flows freely from the source of water through the first end of the water dispenser, and is released through the second end into the encapsulating element, and is ultimately released through the openings of the encapsulating element.

In one embodiment of the invention, the soap dispenser has a first end and a second end, and further comprises a handle, a soap reservoir, and a nozzle. The nozzle is located at the second end of the handle, and the first end comprises female threading such that it can be coupled to a garden hose of any size. The female threading also couples to various adapters. Adapters are rigid or flexible. Adapters couple to various fittings, hoses, connectors or water sources, including but not limited to a spigot, sink, shower head, water tank, or pipe.

In one embodiment of the invention, the water dispenser has a first end and a second end, and further comprises a handle and a nozzle. The nozzle can be located at the second end, and the first end comprises female threading such that it can be coupled to a garden hose of any size in any country. The female threading also couples to various adapters. Adapters connect to various water sources, including but not limited to a spigot, sink, shower, hose, water tank, or pipe.

In one embodiment of the invention, the soap dispenser further comprises a means to release soap and to stop the release of soap into the stream of water flowing through the soap dispenser. The means of releasing soap can be any device known in the art, including but not limited to a turn dial, switch, lever, trigger or button that opens/closes a valve or opening, such that it controls release of soap into the stream of water going through the soap dispenser.

In an alternative embodiment, the soap dispenser comprises a soap reservoir, and a straw or straw-like structure, wherein the straw or straw-like structure is inside the soap dispenser such that one end of the straw or straw-like structure is submerged in soap. The straw or straw-like structure is connected to a pump, lever, trigger or other means, which dispenses soap into the stream of water going through the soap dispenser.

In another embodiment, a soap cartridge containing a soap mixture, or a soap mixture contained in a sealed reservoir, can be affixed to the handle element, such that a specified amount of soap is released into the water stream for a specific period of time. The soap mixture can be sealed with a plastic or rubber top, and more preferably a foil, or foil-like top, such that when the soap cartridge is inserted into the handle the seal is punctured, thus releasing the soap mixture into the handle and out the encapsulating element.

In an additional embodiment, the soap dispenser can include a handle and a soap reservoir, wherein the soap reservoir can be contained completely inside the handle. Soap can be added to the soap reservoir via an inlet, wherein the inlet has a first opening on the exterior of the handle and a second opening which empties into the soap dispenser. The inlet is optionally at the top, bottom, or either side of the handle. The first opening of the inlet is sealed via any known means, including, but not limited to a cap with male I female threading, a plug, a screw or any other stopper.

In any embodiment described herein, “soap” can mean detergent, cleanser, bleach, shampoo, antiseptic, or any other cleaning agent.

Many soap dispensers can be incorporated into embodiments of the invention. The soap dispenser can be any number of soap dispenser known in the art, including but not limited to devices described in U.S. Pat. No. 6,257,786, U.S. Pat. No. 6,571,989, U.S. Pat. No. 7,510,128, U.S. Pat. No. 6,151,728, U.S. Pat. No. 6,000,626, U.S. Pat. No. 2,619,385, all of which are incorporated by reference herein in their entirety.

In another embodiment, the encapsulating element can include one or more encapsulating tubes and a t-joint. The encapsulating tubes can include a first end and a second end. The t-joint can include two or more ends. One end of the t-joint can be called a dispenser connector, and couples to the second end of a soap dispenser or the second end of a water dispenser. The remaining one or more ends of the t-joint, called herein element connectors, can couple with one or more encapsulating tubes. In a preferred embodiment, the t-joint has two element connectors, each element connector is coupled to the first end and second end of the encapsulating tube to create a circular, oval, triangle, hexagon, or other polygon shaped encapsulating element.

In any embodiments described herein, the dispenser connector can be permanently or removeably coupled to the soap dispense or water dispenser by any known means in the art, including but not limited to male I female threading, any adhesive, glue, epoxy, industrial strength plastic adhesive, spring tension or spring tension like push buttons.

In another embodiment, the t-joint can include two element connectors. Each element connector is coupled with the first end of an encapsulating tube to create a horseshoe, crescent moon, circle with a small gap, or any other open shaped encapsulating element. The second end of each encapsulating tube can be coupled to a stopper, which prevents water from escaping from the second end of the encapsulating tube. In a preferable embodiment, the encapsulating tubes can be flexible such that they are able to push apart and slide around an animal, object or person, and then flex back into place such that the animal is surrounded by the encapsulating tubes.

In another embodiment, the t-joint contains three or more element connectors, and each can be coupled to the first end of an encapsulating tube. The second end of each encapsulating tube can be coupled to a stopper, which prevents water from escaping from the second end of the encapsulating tube. This embodiment creates an open multi-dimensional spherical, elliptical or any other polygon shape. In a preferable embodiment the encapsulating tubes can be flexible such that they are able to push apart and slide around an animal, object or person, and then flex back into place such that the animal is surrounded by the encapsulating tubes.

In any of the embodiments described herein, the stopper at second end of an encapsulating tube is optionally removable or permanently coupled to the second end of the encapsulating tube. The stopper can be coupled to the second end of the encapsulating tube by any known means in the art, including but not limited to male I female threading, glue, any adhesive, any industrial strength adhesive, epoxy, spring tension or spring tension like push buttons.

In any of the embodiments described herein, the encapsulating tube comprises one curved, bent, or straight segment. Alternatively, in any of the embodiments described herein, the encapsulating tube can include of two or more curved, bent or straight, segments. The segments of the encapsulating tube, sometimes referred to herein as segments, have a first end and second end. The first end can be coupled to the second end of the encapsulating tube by any known means in the art, including but not limited to male I female threading, glue, any adhesive, any industrial strength adhesive, epoxy, spring tension or spring tension like push buttons.

In a preferred embodiment, each segment has female threading on the first end and male threading on the second end, such that the first end can be coupled with the second end. In another preferred embodiment the segments of the encapsulating tube can have a connector permanently affixed to the first end. In this embodiment, the first end slightly larger than the second end and glides over the second end to fit snuggly around the second end, in a manner that prevents water from escaping. Optionally, the connector locks into place around the second end. Optionally, the connector is fitted with an o-ring to prevent water from escaping. The connector can be made out any suitable waterproof material, including but, not limited, to any rubber, plastic or metal.

In an alternative embodiment, the encapsulating element, as described in any embodiment herein, can be a single molded structure, comprising a t-joint, an encapsulating element, one or more encapsulating tubes and optionally one or more stoppers. This embodiment can be made using injection mold manufacturing techniques or by any other means known to one of skill in the art.

In an alternative embodiment, the soap dispenser and encapsulating element, as described in any embodiment herein, can be manufactured as a single molded structure, comprising soap dispenser (or any portion thereof, such as the soap dispenser casing), a t-joint, an encapsulating element, one or more encapsulating tubes and optionally one or more stoppers. This embodiment may also be manufactured in two molded structures that are then coupled or sealed together to form a single complex molded structure. This embodiment can be made using injection mold manufacturing techniques or by any other means known to one of skill in the art.

In another embodiment, the t-joint and t-joint connector can be coupled to the second end of said soap dispenser permanently by glue, epoxy, melting, stitching, or melding segments together, or any other known method of permanently coupling the materials. In another embodiment the t-joint, t-joint connector, and the soap dispenser can be made using injection mold manufacturing techniques or by any other means known to one of skill in the art.

In another embodiment the encapsulating element can be coupled to the second end of said soap dispenser, such the encapsulating element is easily removable. In one embodiment the encapsulating element can be coupled to the soap dispenser via female and male threading, such that the encapsulating element is easily twisted into place, and easily removed. In another embodiment the encapsulating element can be coupled via spring tension push buttons, or spring tension like push buttons. A user presses on the buttons, which compresses a spring and in turn releases the encapsulating element. The embodiments in this paragraph are preferable because they allow for convenient storage of the washing device, and allow for the opportunity to air dry.

In one embodiment the t-joint can be coupled to the first end of an encapsulating tube, such that the t-joint is easily removable. In another embodiment the encapsulating element can be coupled to the soap dispenser via female and male threading, such that the encapsulating element is easily twisted into place, and easily removed. In yet another embodiment the encapsulating element can be coupled via spring tension push buttons, or spring tension like push buttons. A user presses on the buttons to release the encapsulating element. The embodiments in this paragraph are preferable because they allow for convenient storage of the washing device, and allow for the opportunity to air dry.

Any part of the encapsulating element can include one or more encapsulating tubes, a t-joint and a t-joint connector, wholly or in part, is preferably comprised of plastic, rubber, hose material, metal, metal alloid, or any other flexible or rigid water proof material. In another embodiment, the encapsulating element, wholly or in part, can be constructed of a cylindrical rubber, rubber-like material, or another flexible material, that expands when water-pressure is applied. When the water pressure is removed the material returns to its original flaccid form. An example of this embodiment uses a “Pocket Hose” or hose made of materials similar to those of the Pocket Hose to create any portion of the encapsulating element.

In another embodiment the encapsulating element, wholly or in part, can be constructed out of plastic, metal, rubber, nylon, polyurethane, polyethylene, PVC, or synthetic or natural rubbers polyethylene (LDPE and especially LLDPE), PTFE (Teflon), stainless steel, and other metals. In this embodiment the encapsulating elements made out of flexible materials are optionally reinforced with fibers or steel cord, and such encapsulating elements are reinforced by any common methods, including but not limited to braiding, spiraling, knitting and wrapping of fabric plies. In further embodiments encapsulating elements contain corrugations or bellows, optionally having circumferential or helical reinforcement rings to maintain these corrugated or bellowed structures.

In any embodiments described herein, “coupling”, “couples”, “coupled”, “attaching”, “attaches”, “attached”, “connecting”, “connects” or “connected” can mean directly or indirectly permanently or removeably affixing or coupling two pieces together by any known means in the art, including by not limited to male I female threading, any adhesive, glue, epoxy, industrial strength plastic adhesive, stitching, melting, melding, spring tension, or any other means of coupling described herein. Male I female threading may be comprised of any waterproof rigid material including but not limited to plastic, rubber, metal, or metal alloid.

Further to any embodiment described herein, the encapsulating element can include a circle, rectangle, square, hexagon, octagon, triangle, half circle, crescent moon, a “C”, horseshoe, oval, or any other similar shapes.

Further to any embodiment described herein, the encapsulating element can include an inner surface, and said inner surface has numerous holes, or relief holes, herein after called “openings” to allow for the passage of water and/or soap to escape.

In any embodiment described herein, the encapsulating element can include a multitude of sizes to accommodate different sized and weighted animals, objects, or people. The size of the encapsulating element correlates to the size of the animal, object or person being washed. The numbers of openings also correlate as the size of the encapsulating element. Generally, diameter of the encapsulating element is as small as 4 inches and as large as 40 inches, with as few as 5 openings and as many as 500 openings. Preferably the diameter is between 11 and 16 inches, with 30 to 45 openings, wherein said openings are placed approximately 1 inch away from adjacent openings.

In any embodiment described herein, the encapsulating element can include comprised of encapsulating tubes, sometimes referred to herein in as tubes, wherein the encapsulating tubes are hollow cylindrical or elliptical tubes having an inner surface, and the openings are placed in one or more lines on the inner surface of the encapsulating tube. In one embodiment the openings are bunched together, such that more streams of water arise from one part of the encapsulating tube, and fewer streams of water arise from another part of the encapsulating tube. The openings can be placed between 0.1 inch and 2 inches away from adjacent openings.

In a more preferred embodiment, the openings can be placed equidistant from other openings, such that there is an even distribution of water streams around the encapsulating element, creating streams of water that appear to be spokes on a wheel. The openings can be placed between approximately 0.1 inch and 2 inches away from adjacent openings.

In another embodiment, the encapsulating element can include of encapsulating tubes, wherein the tubes are hollow elongated elliptical, square, rectangular, rounded rectangle, flattened circle, or another shape of tube having an inner surface, wherein the inner surface is planar and wide enough to have openings in two or more parallel lines, such that the openings spray substantially parallel streams of water towards the center of the encapsulating element. The lines of openings can be approximately 0.1 inch and 2 inches apart. In one embodiment the openings can be bunched together, such that more streams of water arise from one part of the encapsulating tube, and fewer streams of water arise from another part of the encapsulating tube. The openings can be placed between approximately 0.1 inch and 2 inches away from adjacent openings. In a more preferred embodiment, the openings can be placed equidistant from other openings, such that there is an even distribution of water streams around the encapsulating element. The openings can be placed between approximately 0.1 inch and 2 inches away from adjacent openings.

In any of the embodiments described herein, the openings can have a diameter such that when average water pressure is applied a stream of water is released from the openings with sufficient force to quickly wet the exterior of an animal, person or object. The exact diameter of the openings depends on the number of openings and size of the encapsulating elements. In a preferred embodiment, the diameter of an opening is approximately 1/32 inch to 3/32 inch.

Another embodiment of this invention can provide a method of washing an animal, object or person using any of the embodiments of the devices described herein. The user can hold the water dispenser handle, turn the dispenser on and pass the encapsulating element back and forth over the animal, object or person and thus saturating the entirety of the animal, object or person with water. When the user is satisfied with the amount of water applied to the animal, object, or person, the means for dispensing soap can be activated, allowing soap from the soap reservoir to mix with the water and soak the animal, object, or person with soapy water. The user can disengage the means for dispensing soap, and clean water exits the openings for a thorough rinse (360 degrees). In an embodiment wherein the animal is a dog, the rinse and wash includes the dog's stomach and under side area.

Another embodiment of this invention can provide a method of rinsing an animal, object or person using any of the embodiments of the devices described herein. The user can hold the water dispenser handle, turn the dispenser on and pass the encapsulating element back and forth over the animal, object or person and thus saturating the entirety of the animal, object or person with water. In an embodiment wherein the animal is a dog, the rinse includes the dog's stomach and under side area.

### BRIEF DESCRIPTION OF THE DRAWINGS

FIG. 1 is a side view of an exemplary washing device in accordance with embodiments of the present invention.

FIG. 2A is an illustration of an exemplary washing device in accordance with embodiments of the present invention.

FIG. 2B is an illustration of an exemplary washing device in accordance with embodiments of the present invention.

FIG. 2C is an illustration of an exemplary washing device in accordance with embodiments of the present invention.

FIG. 2D is an illustration of an exemplary washing device in accordance with embodiments of the present invention.

FIG. 2E illustrates an example of an elliptical encapsulating tube in accordance with embodiments of the present invention.

FIG. 2F illustrates an example of a flattened encapsulating tube in accordance with embodiments of the present invention.

FIG. 2G illustrates an example of an encapsulating element comprising an elliptical encapsulating tube with two lines of openings in accordance with embodiments of the present invention.

FIG. 3A is an illustration of an exemplary washing device in accordance with embodiments of the present invention.

FIG. 3B is an illustration of an exemplary washing device in accordance with embodiments of the present invention.

FIG. 3C illustrates the encapsulating element segments in accordance with embodiments of the present invention.

FIG. 3D is an illustration of an exemplary washing device in accordance with embodiments of the present invention.

FIG. 3E is an illustration of an exemplary washing device in accordance with embodiments of the present invention.

FIG. 3F is an illustration of an exemplary washing device in accordance with embodiments of the present invention.

FIG. 4 is an open side view of an exemplary soap dispenser and t-joint, in accordance with embodiments of the present invention.

FIG. 4A is another view of an exemplary soap dispenser in accordance with embodiments of the present invention.

FIG. 5A illustrates a cross-section of side view of an exemplary water dispenser and an exemplary mechanism for modulating water flow in accordance with embodiments of the present invention.

FIG. 5B illustrates a cross-section of side view of an exemplary soap dispenser and an exemplary mechanism for releasing soap in accordance with embodiments of the present invention.

FIG. 6 illustrates a method of using the washing device.

### DETAILED DESCRIPTION

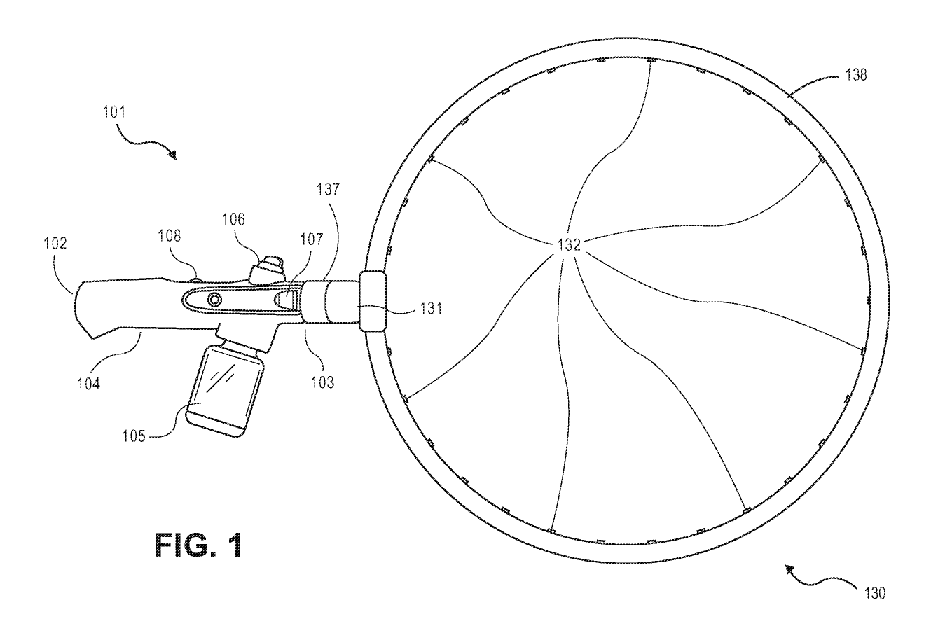

The handheld washing device as shown in FIG. 1 comprises a soap dispenser 101 and an encapsulating element 130. Soap dispenser 101 is coupled to encapsulating element 130. Encapsulating element 130 comprises encapsulating tube 138, t-joint 131, and connector 137. Soap dispenser 101 comprises handle encasement 104, having a first handle end 102 and a second handle end 103. Second handle end 103 is removably coupled to connector 137. Soap dispenser 101 further comprises soap reservoir 105 and soap modulator 106. Soap reservoir 105 is removably coupled to handle encasement 104 by any common means known in the art, including but not limited to male/female threading, snap-locking or any other known means of attachment. Soap dispenser further comprises release button 107. When release button 107 is depressed with sufficient force, encapsulating element 130 can be easily removed. Soap dispenser 101 further comprises water pressure modulator 108 which adjusts the rate of water flow from the water source to encapsulating element 130. Encapsulating tube 138 has a smooth circumferential inner surface lined with multiple openings 132, which release water inward, towards the center of encapsulating tube 138.

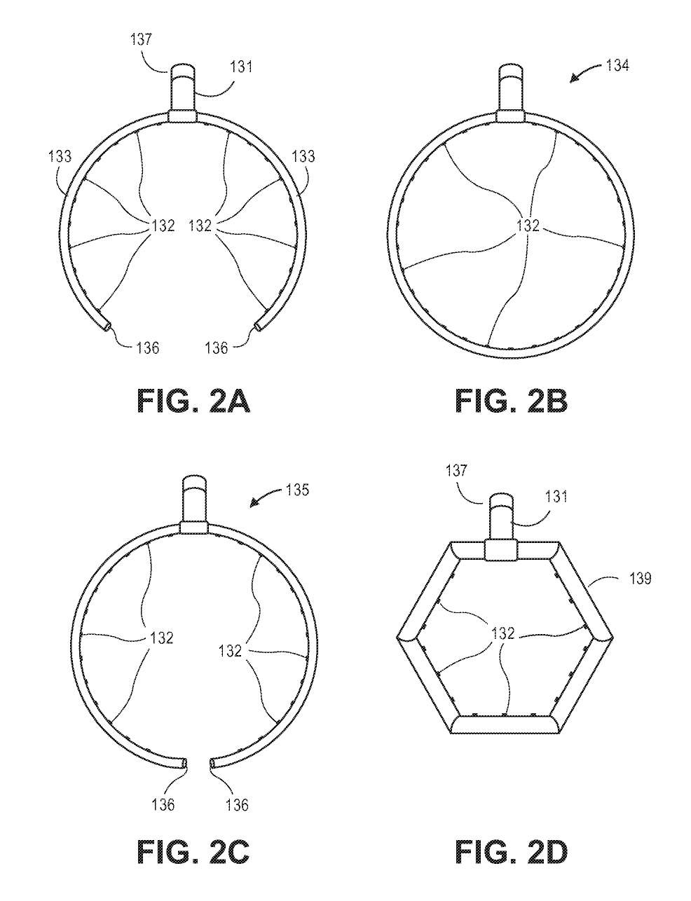

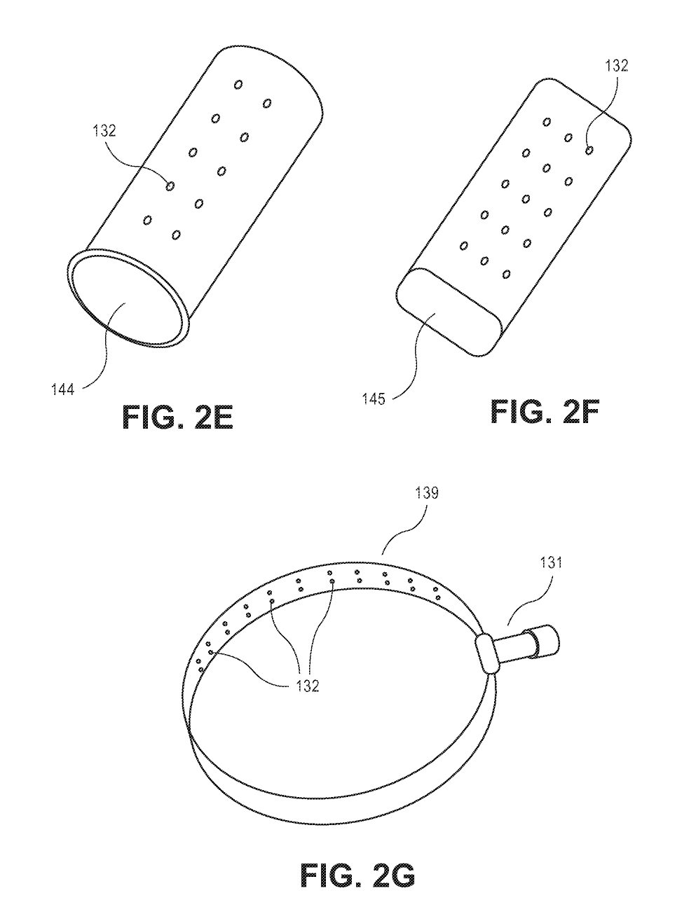

The encapsulating element as shown in FIG. 2A comprises t-joint connector 137, t-joint 131, and two horseshoe-shaped encapsulating tubes 133. Each horseshoe-shaped encapsulating tube 133 has a first end that is coupled with t-joint 131 and a second end that is sealed by stopper 136. Each horseshoe-shaped encapsulating tube 133 further comprises an inner surface lined with multiple openings 132, which release water inward.

FIG. 2B illustrates a circular encapsulating element 134. Circular encapsulating element 134 is one molded segment comprising a t-joint connector, t-joint and circular encapsulating tube, as opposed to separate segments connected together as shown in FIGS. 1 and 2A. Circular encapsulating element 134 further comprises an inner surface lined with multiple openings 132, which release water inward towards the center of encapsulating element 134. Circular encapsulating element 134 is made by mold injection or any other means known in the art, and it is made from materials listed herein, and more preferably is made of molded plastic, molded rubber or tubing.

FIG. 2C illustrates an open-circle encapsulating element 135. Open-circle encapsulating element 135 is one molded segment comprising a t-joint connector, t-joint and “c” shaped or open circle shaped encapsulating tube, as opposed to separate segments connected together as shown in FIGS. 1 and 2A. Open-circle encapsulating element 135 has two ends, which are closed by stopper 136. Open-circle encapsulating element 135 further comprises an inner surface lined with multiple openings 132, which release water inward towards the center of open-circle encapsulating element 135. Open-circle encapsulating element 135 is made by mold injection or any other means known in the art, and is made from materials listed herein in at paragraphs [0028] and [0029], and more preferably is made of molded plastic, molded rubber or tubing.

The encapsulating element as shown in FIG. 2D comprises t-joint connector 137, t-joint 131, and a hexagonal-shaped encapsulating tube 139. Hexagonal-shaped encapsulating tube 139 has a first end and second end, which are coupled with t-joint 131. Hexagonal-shaped encapsulating tube 139 further comprises an inner surface lined with multiple openings 132, which release water inward.

FIG. 2E illustrates portion of an elliptical encapsulating tube 144, comprising an inner surface, which has openings 132 positioned in two lines. The flatness of 144 causes the two lines of openings 132 to release water in substantially parallel streams to adjacent openings.

FIG. 2F illustrates another portion of a flattened elliptical encapsulating tube 145, comprising an inner surface, which has openings 132 positioned in three lines. The flatness of 145 causes the three lines of openings 132 to release water in substantially parallel streams to adjacent openings.

FIG. 2G illustrates encapsulating element 139, which comprises elliptical encapsulating tube 144 having openings 132 positioned in two lines and t-joint 131. In this embodiment, water streams flowing from openings 132 spray inward toward the center of encapsulating element 139, and water streams from the two lines are substantially parallel.

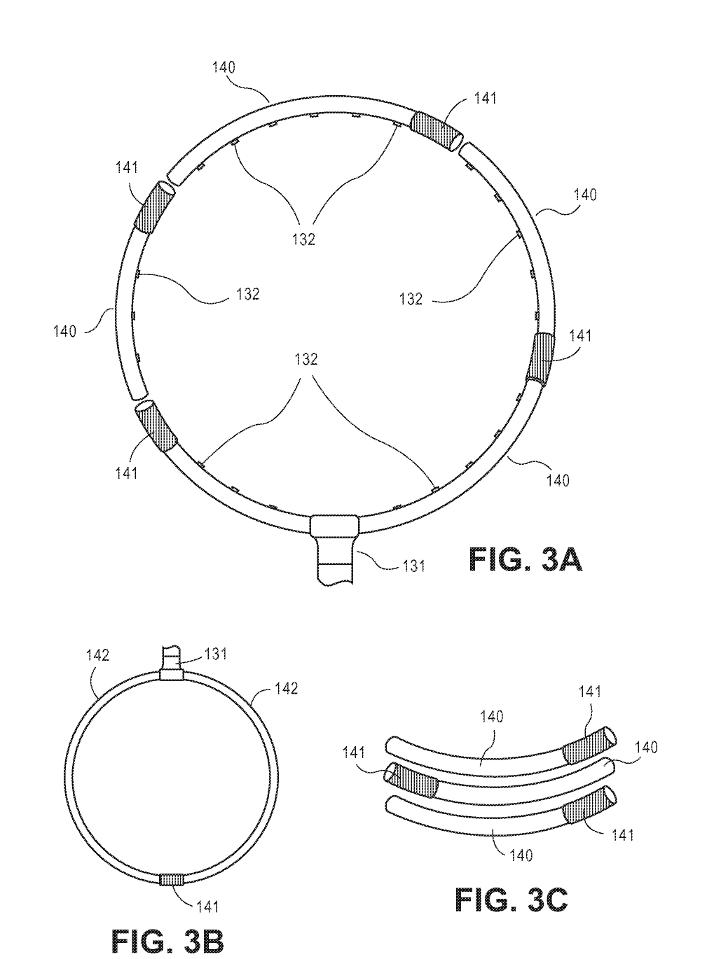

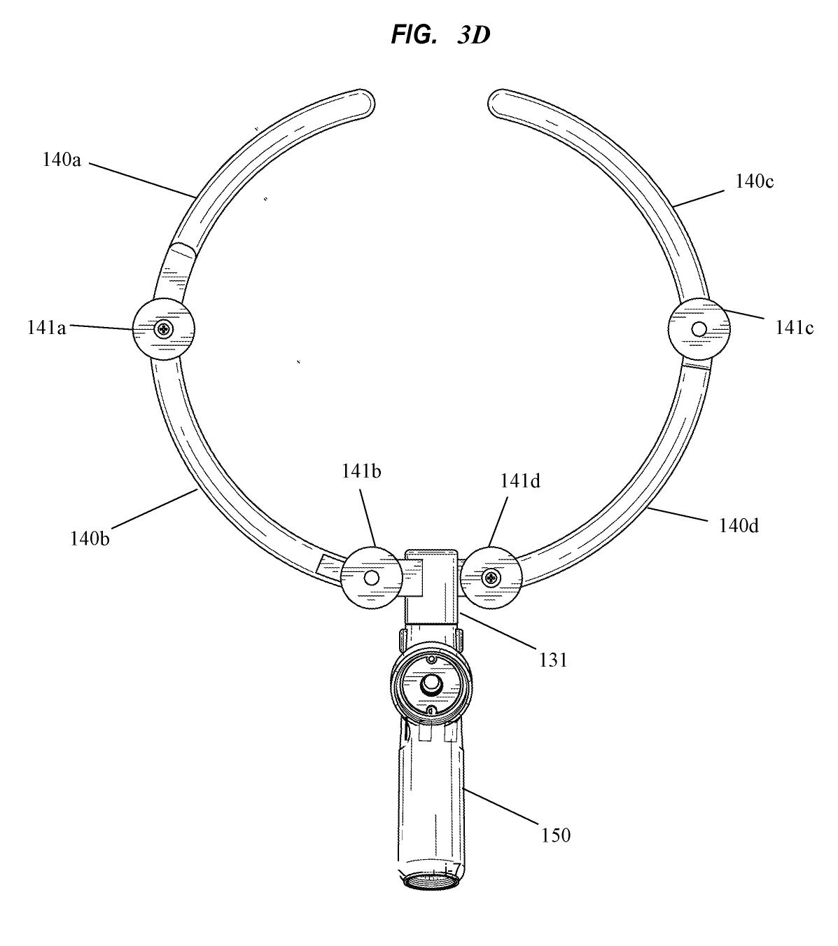

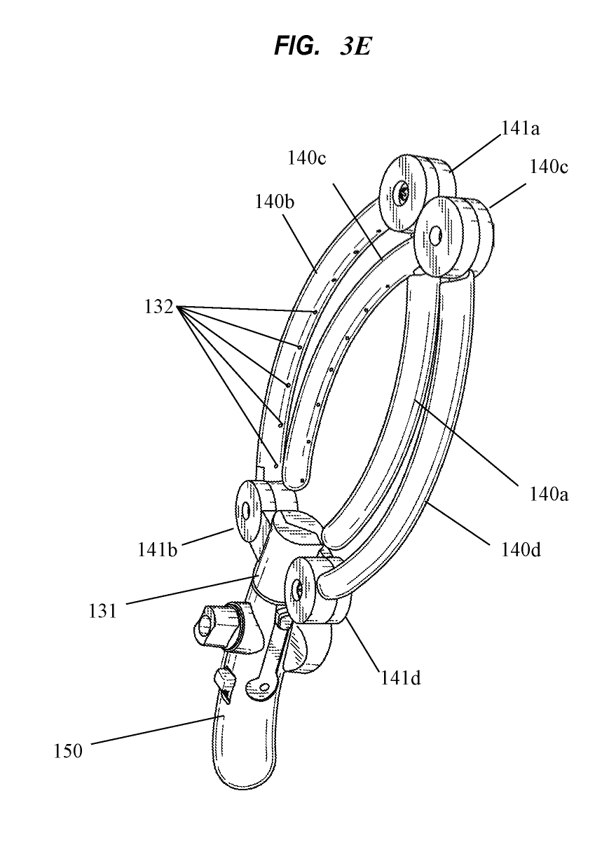

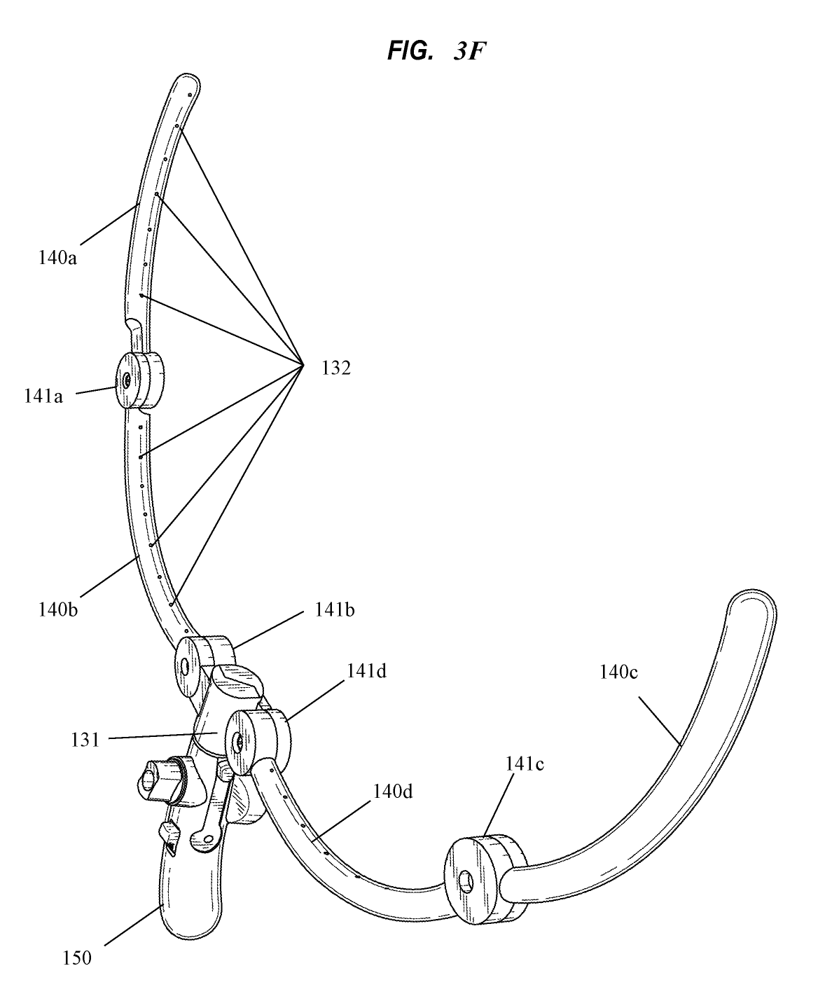

FIG. 3A illustrates yet another encapsulating element comprising segmented encapsulating tubes 140, sometimes herein referred to as segments 140, and encapsulating tube connectors 141, sometimes herein referred to as connectors 141 or tube connecters 141. The diameter of tube connector 141 is such that it fits snuggly with segment 140 with enough friction to prevent water from escaping at this juncture. Additional material, including but not limited to rubber lining or o-rings, is optionally added to 140 or 141 to ensure a water-tight seal. Alternatively, tube connector 141 and segment 140 are coupled via male and female threading, or another water-tight means. Alternatively, 141 represents one end of segmented encapsulating tube 140, wherein connector 141 comprises a means for coupling with the other end of segmented encapsulating tube 140, such means for coupling includes but is not limited to male and female threading. Segment 140 and connector 141 are optionally made from materials listed herein in at paragraphs [0028] and [0029].

FIG. 3B illustrates yet another encapsulating element comprising semicircular encapsulating tubes 142 and encapsulating tube connector 141. Diameter of encapsulating tube connector 141 is such that it fits snuggly with semicircle encapsulating tubes 142 with enough friction to prevent water from escaping at this juncture, or by other means including but not limited to those identified herein at paragraph [0064]. In this embodiment, 141 alternatively represents one end of segmented semicircle encapsulating tube 142, wherein 141 comprises a means for coupling with the other end of segmented semicircle encapsulating tubes 142, such means for coupling includes but is not limited to male and female threading. 142 and 141 are optionally made from materials listed herein in at paragraphs [0028] and [0029].

FIG. 3C illustrates segmented encapsulating tubes 140 and encapsulating tube connectors 141 in a configuration for easy storage.

FIG. 3D shows yet another exemplary encapsulating element. As shown in FIG. 3D, the encapsulating element may include a plurality of segments 140a, 140b, 140c, and 140d coupled to one other via pivoting mechanisms 141a, 141b, 141c, and 141d. According to certain exemplary embodiments, pivoting mechanisms 141a, 141b, 141c, and 141d may include any mechanism that enable segments 140a, 140b, 140c, and 140d to be independently adjusted relative to one another and be adjustably fixed in that position. For example, pivoting mechanisms 141a, 141b, 141c, and 141d can include a ratcheting joint, a tension joint, a hinge joint, a plane joint, a saddle joint, a ball-and-socket joint, or the like.

In operation, segment 140a can adjusted relative to segment 140b via pivoting mechanism 141a. Similarly, segment 140b can be adjusted relative to t-joint 131 via pivoting mechanism 141b. Similarly, segment 140c can be adjusted relative to segment 140d via pivoting mechanism 141c. Further, segment 140d can be adjusted relative to t-joint 131 via pivoting mechanism 141d. Accordingly, the pivoting mechanisms 141a, 141b, 141c, and 141d can enable segments 140a, 140b, 140c, and 140d to be adjusted into a desired configuration for each specific use of the particular use of the encapsulating element. For example, segments 140a, 140b, 140c, and 140d can be adjusted to form a variety of closed-curve polygons or circlular shapes such as, e.g., triangles, quadrilaterals, pentagons, hexagons, heptagons, octagons, circles, ellipses, and ovals. Although FIG. 3D shows the encapsulating element to have four segments and four pivoting mechanisms, the encapsulating element can have any number of segments and/or pivoting mechanisms (e.g., 1, 2, 3, 5, 6, 7, or more) depending on the level of customization of the shape and configuration of the segments that is desired.

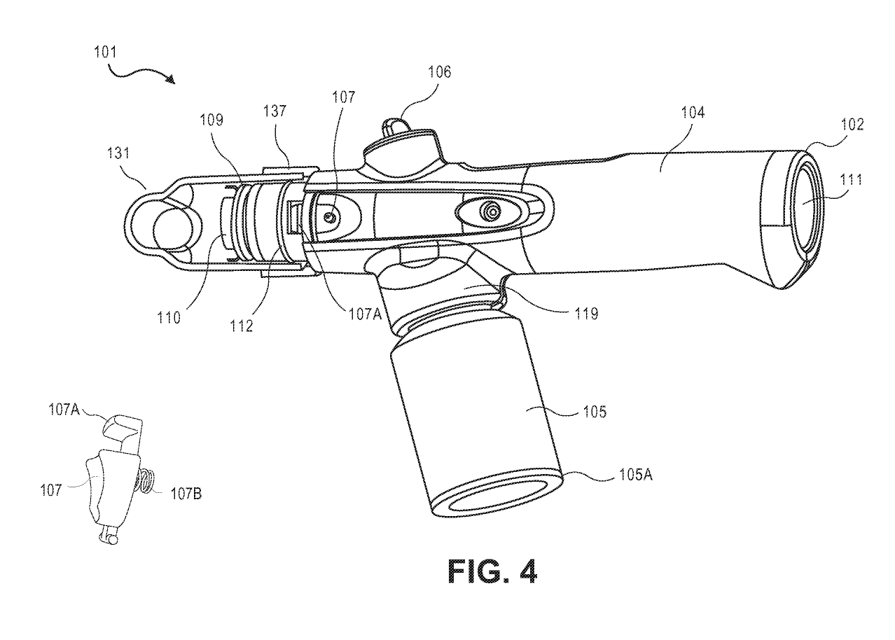

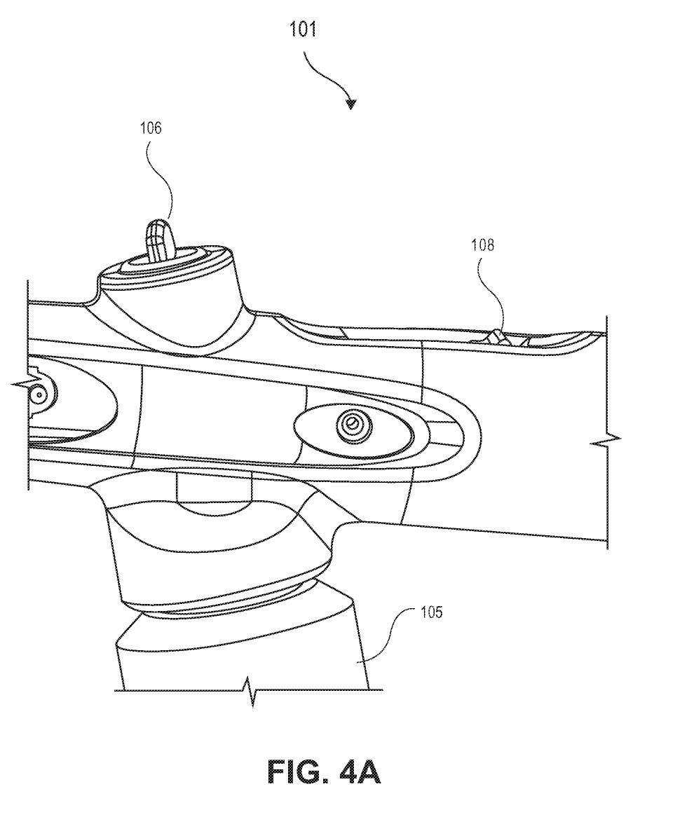

As shown in FIG. 3D, the encapsulating element 140 may be rotatably connected to a handle 150 via the t-joint 131. According to certain exemplary embodiments, the handle 150 may include any mechanism that enables t-joint 131 and encapsulating element 140 to independently rotate relative to the handle 150 and be adjustably fixed in that position. For example, rotating mechanism can include a ball bearing, ball-and-socket joint, gliding joint, or the like. Soap dispenser 101 and t-joint 131 as shown in FIG. 4 illustrates further detail of the device. In this embodiment, the first handle end 102 is fitted with threading 111, such that it couples with a standard garden hose from any country or an adapter that links the soap dispenser to a water source including a dispenser, spigot, shower head, faucet or other common source of water. The top end of soap reservoir 105 is linked to the soap dispenser via a reservoir attachment site 119, and the bottom end of 105 is coupled with soap reservoir plug 105A. 105A is optionally removably or permanently affixed to soap reservoir 105. This view also shows fitted o-ring 112, which is preferably made of a type of rubber. Fitted o-ring 112 buffers friction and prevents water from escaping at the junction between t-joint 131 and soap dispenser 101. A side view of nozzle 110 is illustrated and provides a release point for the stream of water that flows through soap dispenser 101.

FIGS. 3E and 3F show the washing apparatus as illustrated in FIG. 3D in alternative configurations. In the configurations shown in FIGS. 3E and 3F, segment 140a has been adjusted relative to 140b via pivoting mechanism 141a and segment 140c has been adjusted relative to segment 140d via pivoting mechanism 141c. Further, segment 140b has been adjusted relative to t-joint 131 via pivoting mechanism 141b and segment 140d has been adjusted relative to t-joint 131 via pivoting mechanism 141d. Specifically, FIG. 3E illustrates the embodiment as shown in FIG. 3D with segments 140a, 140b, 140c, and 140d folded inwards towards each other via pivoting mechanisms 141a, 141b, 141c, 141d. This configuration of the washing apparatus may be convenient, for example, for storing and/or transporting the washing apparatus. Similarly, FIG. 3F illustrates the embodiment as shown in FIG. 3D with the segments 140a, 140b, 140c, and 140d folded outwards away from each other via pivoting mechanisms 141a, 141b, 141c, 141d. This configuration of the washing apparatus may be useful, for example, when washing large objects.

FIG. 4 also illustrates release button 107, which further comprises release notch 107A, and a cross-sectional view oft-joint 131 and t-joint connector 137. The diameter oft-joint connector 137 is just wide enough to fit snugly around t-joint 131. At the bottom oft-joint connector 137, where t-joint connector couples with soap dispenser 101, a ridge narrows the circumference oft-joint connector 137 to the same diameter oft-joint 131. T-joint 131 and t-joint connector 137 can be permanently coupled such that they create a small gap between the bottom of t-joint connector 137 and the bottom oft-joint 131. Release notch 107A is sized such that it fits into the gap between the bottom oft-joint 131 and the bottom oft-joint connecter 137. Thus, the ridge catches release notch 107 A, and securely couples an encapsulating element to soap dispenser 101. When a user depresses release button 107 with sufficient pressure, spring 107B is compressed, and releases notch 107 A moves inward, such that the ridge oft-joint connector 137 can move freely and t-joint 131 can be removed from soap dispenser 101.

FIG. 4A illustrates water pressure modulator 108. A user can increase or decrease the flow of water through soap dispenser 101 by moving the modulator forward and backwards.

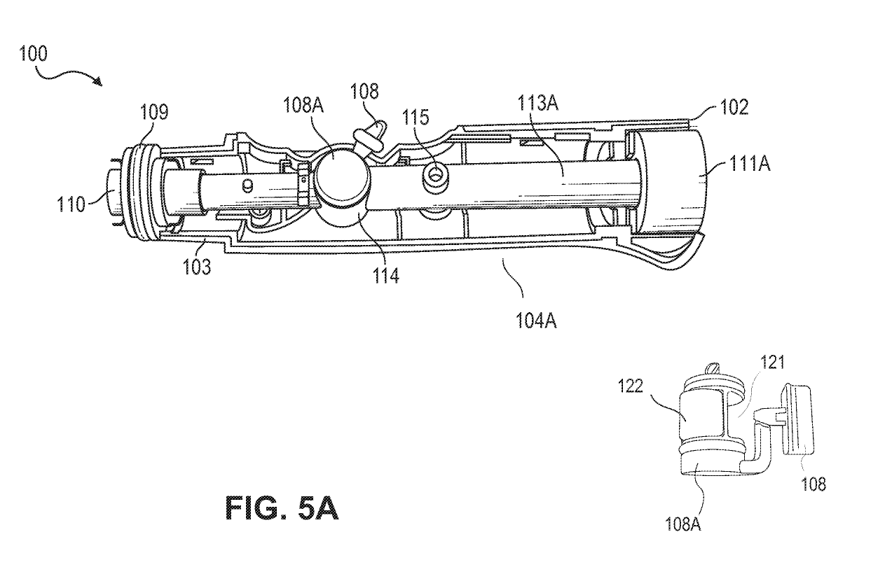

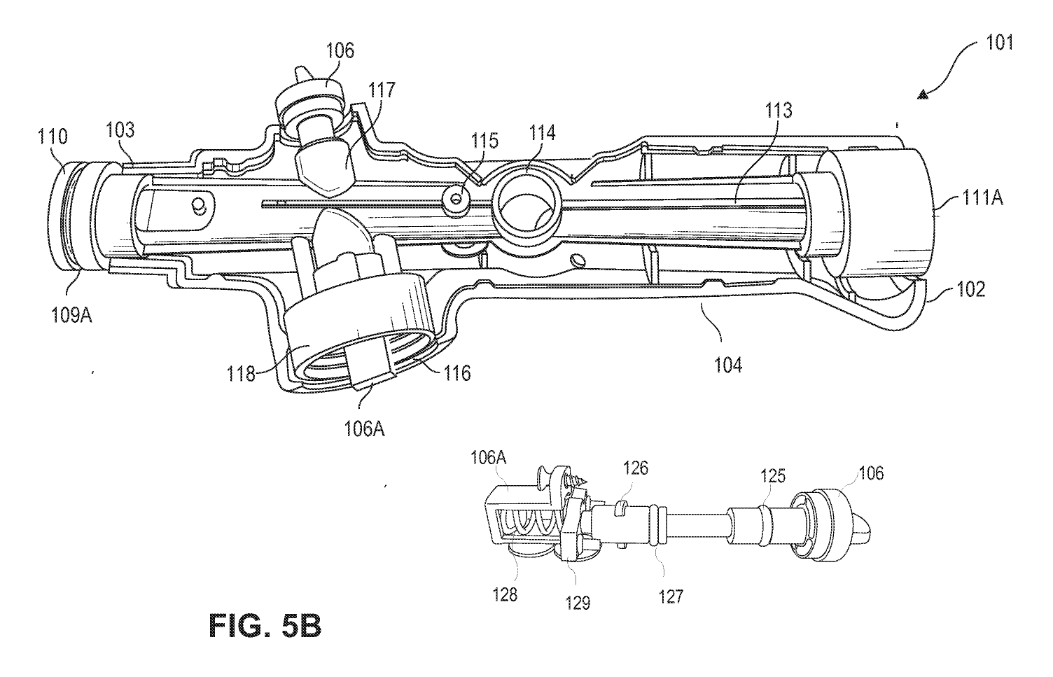

FIG. 5A illustrates a cross-sectional view of a water dispenser 100. Water dispenser 100 comprises a handle encasement 104A having a first handle end 102 and a second handle end 103. Water dispenser 100 further comprises flow tube 113A. At the first end of flow tube 113A is a means for attaching to water source 11 IA. In one embodiment, the means for attaching to a water source is female threading, suitable to couple with male threading of a hose. At second handle end 103 is nozzle 110. The second end is fitted with rubber o-ring 109, which creates a seal between flow tube 113A and an encapsulating element. Point of attachment 115, affixes flow tube 113A to handle encasement 104A. A preferred embodiment uses a screw as a means of attachment. Finally, this view illustrates water pressure modulator 108 permanently connected to cylindrical valve 108A, which is fitted to valve housing 114. Cylindrical valve 108A further comprises opening 121, which is substantially the same size as the interior portion of flow tube 113A. When a user moves 108 in one direction, it turns round valve 108A, such that opening 121 aligns with flow tube 113A to allow maximum water flow. When a user moves 108 in the opposite direction, it turns round valve 108A, such that 122 blocks flow tube 113A to minimize or stop the water flow. 122 is made of any suitable material, including but not limited to rubber or plastic.

Soap dispenser 101 as shown in FIG. 5B illustrates a cross-section of handle encasement 104 having a first handle end 102 and a second handle end 103. Soap dispenser 101 further comprises flow tube 113. First end of flow tube 113 comprises a means for attaching to a water source 111A. In one embodiment, the means for coupling to a water source 111A is female threading, suitable to couple with male threading of a hose. In alternative embodiments, the means for coupling to a water source 111A are any suitable means for coupling described herein. Nozzle 110 and indent 109A, which houses an o-ring, are illustrated as well. Point of attachment 115, affixes flow tube 113 to handle encasement 104. A preferred embodiment uses a screw as a means of attachment. Finally, this view illustrates soap modulator 106. The action of turning soap modulator 106 enables soap to be pulled into the water stream. Soap modulator 106 is connected to 106A, which houses spring 128. When soap modulator 106 is pushed down and turned 90 degrees, spring 128 is depressed, 129 moves downward, and 126 catches and locks the mechanism in place. The resulting action releases soap into the water stream. When soap modulator 106 is turned another 90 degrees it prevents soap from being released into the water stream by unlocking 126, which allows spring 128 to expand, and 129 moves upward stopping or slowing the flow soap into the water stream. The entire mechanism for modulating soap release is housed in 117. A means for coupling to a soap reservoir 118 is illustrated. In this embodiment female threading 116 couples with male threading of a soap reservoir. In alternative embodiments, the means for coupling to a soap reservoir are any suitable means for coupling described herein.

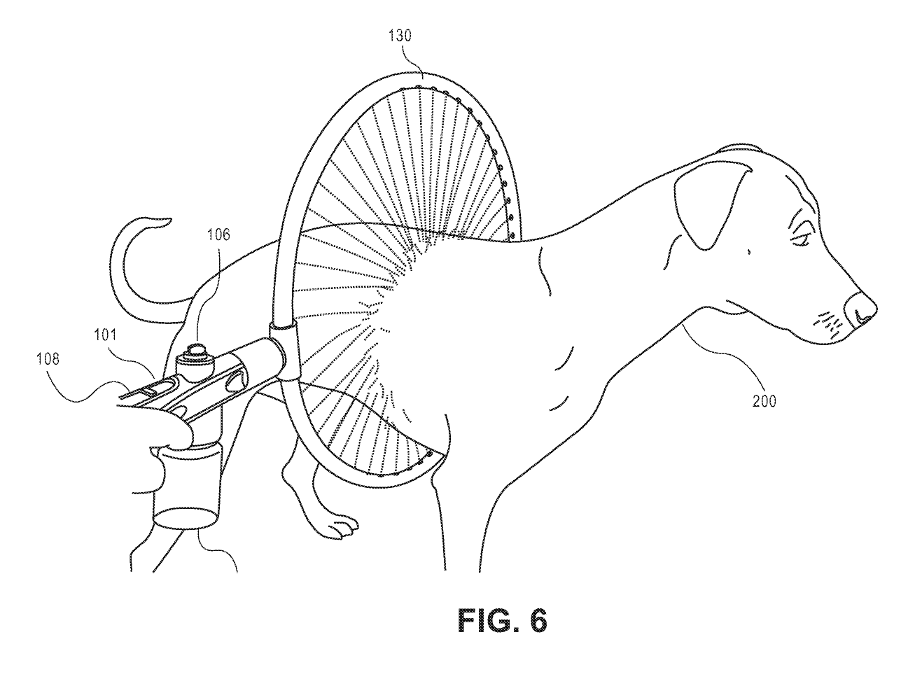

FIG. 6 illustrates a method of washing an animal wherein the user holds handle encasement 104, turns on water pressure modulator 108 to release water such that a water stream travels through soap dispenser 101, passes into encapsulating element 130 and is released via multiple openings 132. At the same time, user positions the encapsulating element around animal 200, moving the encapsulating element 130 back and forth over animal 200, ultimately soaking the animal with water such that water penetrates the animal's fur or coat. When the user is satisfied with the amount of water applied to the animal, user activates soap modulator 106 such that it releases soap (or another cleaning agent) into the water stream flowing through soap dispenser 101, soapy water passes through encapsulating element 130 and soapy water is released via multiple openings 132, ultimately soaking the animal with soapy water. When the user is satisfied with the amount of soap applied to animal 200, user disengages soap modulator 106, such that only clean water passed through encapsulating element 130 and exits openings 132. Again, user positions the encapsulating element around animal 200, moving the encapsulating element 130 back and forth over animal 200, thoroughly rinsing the animal.

The embodiments and examples shown above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of the disclosure. For a better understanding of the disclosure, reference should be had to the accompanying drawings and descriptive matter in which there is illustrated exemplary embodiments of the present invention.

What is claimed is:

1. A washing device, comprising:
a connector configured to removably couple the washing device to a fluid source;
an encapsulating element including a first segment and a second segment, the encapsulating element including a plurality of openings;
a pivoting mechanism coupling the first and second segments, the pivoting mechanism providing relative adjustment between the first and second segments; and
a flow path providing fluid communication from the fluid source to the plurality of openings when the washing device is coupled to the fluid source via the connector.

2. The washing device of claim 1, further comprising a third segment and a fourth segment and a second pivoting mechanism coupling the third and fourth segments, the second pivoting mechanism providing relative adjustment between the third and fourth segments.

3. The washing device of claim 1, further comprising a soap dispensing mechanism configured to provide a soap to the flow path.

4. The washing device of claim 1, further comprising a water pressure modulator.

5. The washing device of claim 1, wherein the encapsulating element is comprised of a flexible flaccid material, which expands when fluid pressure is applied, and returns to its original flaccid form when fluid pressure is removed.

6. The washing device of claim 1, further comprising a handle rotatably coupled to the encapsulating element.

7. The washing device of claim 6, further comprising a third pivoting mechanism coupling the first segment to the handle and a fourth pivoting mechanism coupling the third segment to the handle, the third pivoting mechanism providing relative adjustment between the first segment and the handle and the fourth pivoting mechanism providing relative adjustment between the third segment and the handle

8. A washing device, comprising:
a connector configured to removably couple the washing device to a fluid source;
an encapsulating element including a plurality of openings;
a handle;
a pivoting mechanism coupling the encapsulating element to the handle, the pivoting mechanism providing relative adjustment between the encapsulating element and the handle; and
a flow path providing fluid communication from the fluid source to the plurality of openings when the washing device is coupled to the fluid source via the connector.

9. The washing device of claim 8, wherein the encapsulating element includes a first segment coupled to a second segment via a second pivoting mechanism, the second pivoting mechanism providing relative adjustment between the first and second segments.

10. The washing device of claim 9, wherein the encapsulating element includes a third segment coupled to the handle via a third pivoting mechanism, the third pivoting mechanism providing relative adjustment between the third segment and handle.

11. The washing device of claim 10, wherein the encapsulating element includes a fourth segment coupled to the third segment via a fourth pivoting mechanism, the fourth pivoting mechanism providing relative adjustment between the third segment and the fourth segment.

12. The washing device of claim 8, further comprising a soap dispensing mechanism configured to provide a soap to the flow path.

13. The washing device of claim 8, further comprising a water pressure modulator.

14. The washing device of claim 8, wherein the encapsulating element is comprised of a flexible flaccid material, which expands when fluid pressure is applied, and returns to its original flaccid form when fluid pressure is removed.

15. A washing device, comprising:
a connector configured to removably couple the washing device to a fluid source;
an encapsulating element having a plurality of openings coupled to the connector; and
a flow path providing fluid communication from the fluid source to the plurality of openings when the washing device is coupled to the fluid source via the connector.

16. The washing device of claim 15, further comprising a handle rotatably coupled to the encapsulating element.

17. The washing device of claim 15, further comprising a soap dispensing mechanism configured to provide a soap to the flow path.

18. The washing device of claim 15, further comprising a water pressure modulator.

19. The washing device of claim 15, wherein the encapsulating element is comprised of a flexible flaccid material, which expands when fluid pressure is applied, and returns to its original flaccid form when fluid pressure is removed.
